(19) United States
(12) Patent Application Publication
(10) Pub. No.: US 2007/0254112 A1
(43) Pub. Date: Nov. 1, 2007

(54) Apparatus and method for high utilization of process chambers of a cluster system through staggered plasma cleaning

(75) Inventors: Takako Takehara, Hayward, CA (US); Inchen Huang, Fremont, CA (US); John M. White, Hayward, CA (US)

Correspondence Address: PATTERSON & SHERIDAN, LLP, 3040 POST OAK BOULEVARD, SUITE 1500, HOUSTON, TX, 77056, US

(73) Assignee: Applied Materials, Inc.

(21) Appl. No.: 11/411,666

(22) Filed: Apr. 26, 2006

(51) Int. Cl. B08B 6/00; B08B 9/00; H05H 1/24

(52) U.S. Cl. 427/569; 134/1.1; 134/22.1

(57) ABSTRACT

A method for processing a plurality of substrates in a processing system having four or more process chambers is provided. Each substrate is processed in at least four of the four or more process chambers. Each of the four or more process chambers is cleaned after processing fifteen or less substrates, wherein cleaning of each chamber is scheduled at distinct, non-overlapping time periods to enhance throughput of the substrates through the processing system.

### BACKGROUND OF THE INVENTION

1. Field of the Invention

Embodiments of the present invention generally relate to substrate processing apparatus and methods, such as apparatus and methods for flat panel display processing (i.e., liquid crystal displays, organic light emitting diodes (OLEDs), and other types of flat panel displays), semiconductor substrate processing, and solar panel processing.

2. Description of the Related Art

Fabrication of semiconductor integrated circuits (IC) and flat panel display (FPD) devices require processing of multilayer film stacks to create devices, conductors and insulators on a substrate. In general, the substrate for device fabrication is subjected to various processes, such as sputtering, chemical vapor deposition (CVD), physical vapor deposition (PVD), lithography, etching, ion implantation, ashing, cleaning, heating, annealing, and the like repeated multiple times in a specific multi-step fabrication sequence to process layers of metal and silicon containing films thereon. Typically, a process chamber can be configured to deposit a single layer on a substrate. In addition, a number of process chambers may be coupled together via transfer chamber for multi-substrate processing in a multi-substrate processing platform, such as a clustertool.

In a typical operation of process chambers of a cluster tool system, each process chamber may be plasma cleaned after processing one or more substrates to remove deposited materials and other contaminants from the interior surfaces of the chamber. The process chamber may be plasma cleaned without having to expose the chamber or vent the chamber to atmosphere. One problem with prior operation of cluster tool systems is that plasma cleaning of the processing chambers may be time consuming and may reduce the throughput of the numbers of the substrates through the cluster tool. For example, while a plasma chamber is being cleaning, a robot that may serve several chambers may be waiting to deliver a substrate to that particular plasma chamber and thus the throughput may be affected.

Therefore, there is a need for an improved apparatus and a method of plasma cleaning of process chambers of a cluster tool system.

### SUMMARY OF THE INVENTION

One embodiment provides a method for processing a plurality of substrates in a processing system having four or more process chambers. The method generally includes processing each substrate in at least one of the four or more process chambers, and plasma cleaning each of the four or more process chambers after processing one or more substrates, wherein the four or more processing chambers are cleaned at distinct, non-overlapping time periods selected by a controller to enhance throughput of the substrates through the processing system.

Another embodiment provides a method for processing a plurality of substrates in a processing system having five or more processing chambers. The method generally includes processing twenty or less substrates in each one of the five or more process chambers before plasma cleaning each process chamber, plasma cleaning the five or more process chambers, wherein each plasma cleaning is performed at a distinct, non-overlapping time period.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a plan view of an exemplary cluster tool system utilizing an embodiment of the invention;

FIG. 2 depicts a schematic cross-sectional view of a processing chamber according to an embodiment of the invention;

FIG. 3 depicts a flow diagram of an exemplary method for process monitoring and plasma cleaning scheduling according to one embodiment of the invention;

FIG. 4 depicts another flow diagram of an exemplary method for process monitoring and plasma cleaning scheduling according to one embodiment of the invention; and

FIG. 5 depicts a chronological plot of chamber activity, including chamber plasma cleaning, utilizing the invention.

### DETAILED DESCRIPTION

The invention provides methods for substrate processing and cleaning scheduling within a cluster tool, which is configured for multi-substrate processing. Substrate chamber plasma cleaning times are scheduled alternatively at distinct, non-overlapping time periods for a cluster tool having four or more processing chambers for in situ processing of a plurality of large area substrates, resulting in improved throughput, where each process chamber is cleaned after processing one or more substrates.

In one embodiment, a cluster type substrate processing system is provided and it may include a first CVD process chamber configured to deposit a first material layer on a substrate and a second CVD process chamber for in situ deposition of a second material layer over the first material layer without breaking vacuum or any surface treatment on the surface of the substrate. In another embodiment, the substrate processing system is also configured to include other types of process chambers to perform additional etching, deposition, annealing, and cleaning processes.

In one embodiment, the substrate processing system may include a minimum of three CVD chambers designated to sequentially deposit multiple materials.

In one embodiment, the substrate processing system may include a minimum of four deposition chambers designated to sequentially deposit multiple materials.

The substrates used in the invention may be of varying shapes or dimensions. For flat panel display application, the substrate may comprise a material that is essentially optically transparent in the visible spectrum, for example glass or clear plastic. For example, for thin film transistors applications, the substrate may be a large area glass substrate having a high degree of optical transparency with a surface area of about 370 mm×470 mm or larger, such as about one square meters or larger. However, the invention is equally applicable to substrate processing of any types and sizes. Substrates of the invention can be circular, square, rectangular or polygonal for flat panel display manufacturing.

In one embodiment, the substrate processing system of the invention is adapted to process a rectangular substrate. The surface area of a rectangular substrate for flat panel display is typically large, for example, a rectangle of about one square meter or larger, such as at least about 300 mm by about 400 mm, e.g., about 120,000 mm² or larger. In addition, the invention applies to any devices, such as flat panel display (FPD), flexible (rollable) display, organic light emitting diode displays, flexible organic light emitting diode (FOLED) display, polymer light emitting diode (PLED) display, liquid crystal displays (LCD), organic thin film transistor, active matrix, passive matrix, top emission device, bottom emission device, solar cell, solar panel, etc., and can be on any of the silicon wafers, glass substrates, metal substrates, plastic films (e.g., polyethylene terephthalate (PET), polyethylene naphthalate (PEN), etc.), plastic epoxy films, among others.

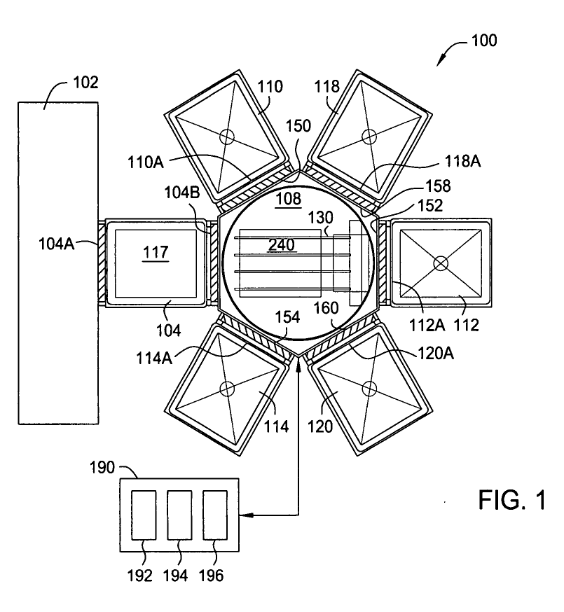

FIG. 1 depicts a plan view of an exemplary cluster tool system 100 utilizing an embodiment of the invention. The cluster tool system 100 may be an AKT-20K system, available from AKT, a subsidiary of Applied Materials, Inc., of Santa Clara, Calif. Other equipment that may be used for this process includes the 4300, 3500, 5500, 10K, 15K, and 25K chambers, also available from AKT, a division of Applied Materials, Inc. of Santa Clara, Calif. Cluster tool system 100 includes substrate processing chambers 110, 118, 112, 120, and 114 suitable for chemical vapor deposition processes to generate multi-layers material on a substrate 240 according to embodiments of the invention. The substrate processing system 100 typically includes a transfer chamber 108 coupled to a factory interface 102 via a load lock chamber 104.

The factory interface 102 generally includes one or more substrates stored in substrate storage cassettes. The substrate storage cassettes are typically removably disposed in a plurality of storage bays/compartments formed inside the factory interface 102. The factory interface 102 may also include an atmospheric robot, such as a dual blade atmospheric robot (not shown). The atmospheric robot is adapted to transfer one or more substrates between the one or more substrate storage cassettes and the load lock chamber 104. Typically, the factory interface 102 is maintained at or slightly above atmospheric pressure and the load lock chamber 104 is disposed to facilitate substrate transfer between a vacuum environment of the transfer chamber 108 and a generally ambient environment of the factory interface 102. The substrate 240 processed by the substrate processing systems of the invention can be transferred from the factory interface 102 to the load lock chamber 104 for processing of a fabrication sequence including two or more material layer deposition on one or more substrates 240.

In one embodiment, processing chambers 110, 118, 112, 120, and 114 of the substrate processing system of the invention are designated to process multiple-layer deposition process where multiple thin layers are deposited on substrates 240 in multiple chambers. In one embodiment, a substrate may sequence through one or more chambers for substrate processing according to a predetermined schedule. The substrate processing system 100 may also include a controller 190 adapted to execute a software-controlled multi-substrate processing sequence.

The controller 190 is included to interface with and control various components of the substrate processing systems of the invention. The controller 190 typically includes a central processing unit (CPU) 194, support circuits 196 and a memory 192. The CPU 194 may be one of any form of computer processor that can be used in an industrial setting for controlling various chambers, apparatuses and chamber peripherals. The memory 192, any software, or any computer-readable medium coupled to the CPU 194 may be one or more readily available memory devices, such as random access memory (RAM), read only memory (ROM), hard disk, CD, floppy disk, or any other form of digital storage, for local or remote for memory storage. The support circuits 596 are coupled to the CPU 194 for supporting the CPU 194 in a conventional manner. These circuits include cache, power supplies, clock circuits, input/output circuitry, subsystems and the like.

The controller 190 is used to control operation of the substrate processing system, including any transferring among the load lock chamber 104, the transfer chamber 108, process chambers (e.g., the first, second, third, fourth and fifth CVD chambers 110, 118, 112, 120 and 114), deposition processes performed therein and scheduling of chamber plasma cleaning. The controller 190 is also used to control processing/deposition time performed by the process chambers, and the timing for the movements of the transfer robot 130, including, without limitation, rotating around various chambers, vertically moving up and down, and extending and retracting in and out of the load lock chamber, the transfer chamber, and the process chambers, etc. The controller 190 execute these movements and timing according to a scheme of a predetermined fabrication sequence for processing one or more substrates and depositing a multi-layer film stack thereon.

In one embodiment, the controller 190 of the invention is used to control movements of one or more substrates being processed concurrently within the substrate processing system. Specifically, the control of substrate movement by various substrate transfer or loading mechanisms (e.g., transfer robot 130, the transfer chambers 108, the load lock chamber 104, etc.) and any software associated therewith are linked to the software required for controlling different process time and process conditions for the process chambers or CVD chambers of the invention.

Cluster tool system 100 contains at least one plasma processing chamber that is capable of depositing a thin film of material layer. The cluster tool system 100 may include a preheating chamber in addition to processing chambers. In another embodiment, a process chamber may also be capable of preheating as well as processing a substrate within the processing chamber. In one embodiment, the chambers are capable of depositing one or more films layers such as metal, dielectric, conductive, silicon containing and other materials.

The cluster tool 100 represents a cluster tool that can be used to process substrates (not shown) without exposing the substrates to air. Cluster tool 100 comprises a transfer chamber 108 to which load lock chamber 104 is connected. The transfer chamber 108, loadlock chamber 104, and processing chambers 110, 118, 112, 120, and 114 are sealed together to form a closed environment in which the system is operated at internal pressures of about 10 mTorr to about 1 Torr. Load lock chamber 104 has closable openings comprising load door 104A to transfer the substrates 240 into cluster tool 100. Substrates (not shown) are transferred to the loadlock chamber 104 from the factory interface 102 by use of an atmospheric robot (not shown).

The loadlock chamber 104 may contain a cassette 117 or one or more shelves to supports substrates therein. In another embodiment, the load lock chamber 104 may have one or more evacuable chambers having one or more slots. In one embodiment, cassettes 117 in loadlock chamber 104 are mounted on an elevator assembly (not shown) to raise and lower the cassettes 117 incrementally by the height of one shelf. To load lock chamber 104, load door 104A is opened and a substrate 240 is placed on a shelf in cassette 117 in loadlock chamber 104. The elevator assembly then raises cassette 117 by the height of one shelf so that an empty shelf is opposite to load door 104A. Another substrate is placed on the empty shelf and the process is repeated until all of the shelves of cassette 117 are filled. At that point, load door 104A is closed and loadlock chamber 104 is evacuated to the pressure in cluster tool 100.

A slit valve 104B on the inside wall of loadlock chamber 104 adjacent to transfer chamber 108 is then opened. Substrates 240 are transferred by means of a transfer robot 130 in transfer chamber 108 to a substrate processing chamber, for example, substrate processing chamber 112, where they are preheated to a desired temperature. In one embodiment, a substrate 240 is heated in the substrate processing chamber 112 to a temperature in the range of about 250° C. to about 450° C. In another embodiment, a substrate 240 is pre-heated in the load lock chamber 104 to a temperature in the range of about 250° C. to about 450° C., and thus a preheating step may be performed before a substrate is transferred to a processing chamber. Yet, in another embodiment of the invention, a preheating chamber may be used instead of a processing chamber and a substrate 240 may be preheated in a preheating chamber, and then it may be transferred to a substrate processing chamber. Transfer robot 130, which is controlled by a controller 190, is used to withdraw a substrate from cassette 117 of loadlock chamber 104, insert the substrate in a substrate processing chamber, for example, substrate processing chamber 112 for a first process step, and after processing, withdraw the substrate and inserting it in another substrate processing chamber for example, substrate processing chamber 118 for a second process step.

Each processing chamber 110, 118, 112, 120, and 114 is optionally fitted on its inner walls 110A, 118A, 112A, 120A, and 114A, respectively, with its associated slit valve 150, 158, 152, 160, and 154, for isolation of the process gases.

In one embodiment, processing chambers 110, 118, 112, 120, and 114 may be: plasma enhanced Chemical Vapor deposition (PECVD), High Density Chemical Vapor Deposition (HDPCVD), thermal CVD, Low Pressure Chemical Vapor Deposition (LPCVD), Physical Vapor Deposition (PVD), Etch, plasma treatment, anneal chambers or they may be other suitable processing chambers.

After the substrate 240 is processed in at least one of the processing chambers 110, 118, 112, 120, and 114, the substrate is transferred to cassette 117 of the load lock chamber 104. The substrate may be cooled in the cool down chamber by use of a cooling surface which removes heat from the substrates mounted in the cassette 117. The cooling surface is cooled using a conventional heat exchanging fluid flowing through a heat exchanger mounted to the cooling surface. Once the substrates has reached a desired temperature, typically in a range between about 20 and about 150° C., the substrate is removed from the chamber 104 through an opened load door 104A and placed in one of the substrate storage positions (not shown) in the interface 102.

In fabrication of electronic devices, materials are deposited on substrates in processing chambers 110, 118, 112, 120 and 114. The deposition processes typically result in deposition of some of the material on the walls and on components of the processing chambers 110, 118, 112, 120 and 114. The material deposited on chambers walls and on the components can affect the deposition rate from substrate to substrate as well as the uniformity of the depositions on the substrates. As such, the controller 190 maintains a count of the number of processes and duration of processes that each chamber undergoes, and maintains a scheduled plasma cleaning in such a way as to minimize the impact on throughput.

Because the chambers are usually part of an integrated tool to rapidly process substrates, it is essential that maintenance and cleaning of the chambers require minimal time. To reduce the likelihood of contamination and thus improve the throughput of the chambers, effective and timely cleaning the surfaces of the chambers is desirable. Plasma cleaning removes silicon residues, carbon residues, and other containments deposited on the chamber walls and on the components during processing. In one embodiment of the present invention, the mechanisms for removing the silicon or carbon containing deposits from the surfaces of the chamber may include in situ RF plasma clean, remote plasma, or RF-assisted remote plasma clean. The in situ RF plasma clean method introduces a fluorine containing precursor to the deposition chamber and dissociates the precursor with RF plasma. The atomic fluorine neutrally charged particles clean by chemically etching the deposits.

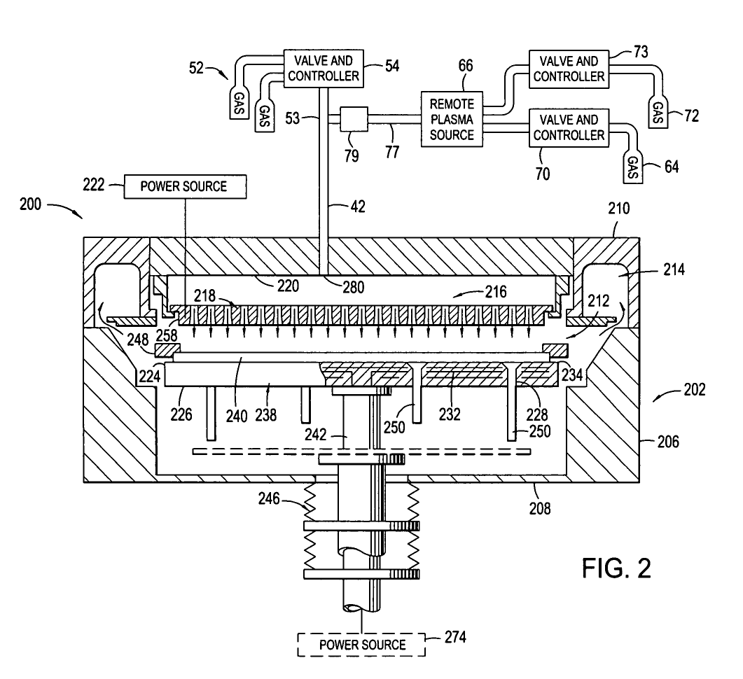

FIG. 2 is a schematic cross-sectional view of a processing chamber according to an embodiment of the present invention. The system 200 generally includes a processing chamber 202 coupled to a gas source 52. The processing chamber 202 has walls 206 and a bottom 208 that partially define a process volume 212. The process volume 212 is typically accessed through a port (not shown) in the walls 206 that facilitate movement of a substrate 240 into and out of the processing chamber 202. The walls 206 and bottom 208 are typically fabricated from aluminum, stainless steel, or other materials compatible with processing. The walls 206 support a lid assembly 210 that contains a pumping plenum 214 that couples the process volume 212 to an exhaust system that includes various pumping components (not shown).

A gas inlet conduit or pipe 42 extends into the entry port 280 and is connected through a gas switching network 53 to sources of various gases. A gas supply 52 contains the gases that are used during deposition. The particular gases that are used depend upon the materials that are to be deposited onto the substrate. The process gases flow through the inlet pipe 42 into the entry port 280 and then into the chamber 212. An electronically operated valve and flow control mechanism 54 controls the flow of gases from the gas supply into the entry port 280.

A second gas supply system also is connected to the chamber through the inlet pipe 42. The second gas supply system supplies gas that is used to clean the inside of the chamber after a sequence of deposition runs. In one embodiment, NF₃ or other fluorine containing gases may be used for cleaning. As used herein, the phrase “cleaning” refers to removing deposited material from the interior surfaces of the chamber. In some situations, the first and second gas supplies can be combined.

The second gas supply system includes a source of a precursor gas 64 such as sulfur hexafluoride, a remote plasma source 66 which is located outside and at a distance from the deposition chamber, an electronically operated valve and flow control mechanism 70, and a conduit or pipe 77 connecting the remote plasma source to the deposition chamber 202. Such a configuration allows interior surfaces of the chamber to be cleaned using a remote plasma source.

The second gas supply system also includes one or more sources of one or more additional gases 72 such as oxygen or a carrier gas. The additional gases are connected to the remote plasma source 66 through another valve and flow control mechanism 73. The carrier gas aids in the transport of the activated species to the deposition chamber and can be any non-reactive gas that is compatible with the particular cleaning process with which it is being used. For example, the carrier gas may be argon, nitrogen, or helium. The carrier gas also may assist in the cleaning process or help initiate and/or stabilize the plasma in the deposition chamber.

Optionally, a flow restrictor 79 is provided in the pipe 77. The flow restrictor 79 can be placed anywhere in the path between the remote plasma source 66 and the deposition chamber 202. The flow restrictor 79 allows a pressure differential to be provided between the remote plasma source 66 and the deposition chamber 202. The flow restrictor 79 may also act as a mixer for the gas and plasma mixture as it exits the remote plasma source 66 and enters the deposition chamber 202.

The valve and flow control mechanism 70 delivers gas from the precursor gas source 64 into the remote plasma source 66 at a user-selected flow rate. The remote plasma source 66 may be an RF plasma source. The remote plasma source 66 activates the precursor gas to form a reactive species which is then flowed through the conduit 77 into the deposition chamber via the inlet pipe 42. The entry port 280 is, therefore, used to deliver the reactive gas into the interior region of the deposition chamber. In the described implementation, the remote plasma source 66 is an inductively coupled remote plasma source.

The lid assembly 210 provides an upper boundary to the process volume 212. The lid assembly 210 typically can be removed or opened to service the processing chamber 202. In one embodiment, the lid assembly 210 is fabricated from aluminum (Al). The lid assembly 210 includes a pumping plenum 214 formed therein coupled to an external pumping system (not shown). The pumping plenum 214 is utilized to channel gases and processing by-products uniformly from the process volume 212 and out of the processing chamber 202.

The gas distribution plate assembly 218 is coupled to an interior side 220 of the lid assembly 210. The gas distribution plate assembly 218 includes a perforated area 216 through which process and other gases are delivered to the process volume 212. The perforated area 216 of the gas distribution plate assembly 218 is configured to provide uniform distribution of gases passing through the gas distribution plate assembly 218 into the process volume 212. Gas distribution plates that may be adapted to benefit from the invention are described in commonly assigned U.S. patent application Ser. No. 09/922,219, filed Aug. 8, 2001 by Keller, et al.; Ser. No. 10/140,324, filed May 6, 2002; and Ser. No. 10/337,483, filed Jan. 7, 2003 by Blonigan, et al.; U.S. Pat. No. 6,477,980, issued Nov. 12, 2002 to White, et al.; and U.S. patent application Ser. No. 10/417,592, filed Apr. 16, 2003 by Choi, et al., which are hereby incorporated by reference in their entireties.

The diffuser plate 258 is typically fabricated from stainless steel, aluminum (Al), anodized aluminum, nickel (Ni) or other RF conductive material. The diffuser plate 258 is configured with a thickness that maintains sufficient flatness to not adversely affect substrate processing. In one embodiment the diffuser plate 258 has a thickness between about 1.0 inch to about 2.0 inches.

A temperature controlled substrate support assembly 238 is centrally disposed within the processing chamber 202. The support assembly 238 supports a substrate 240 during processing. In one embodiment, the substrate support assembly 238 comprises an aluminum body 224 that encapsulates at least one embedded heater 232. The heater 232, such as a resistive element, disposed in the support assembly 238, is coupled to an optional power source and controllably heats the support assembly 238 and the substrate 240 positioned thereon to a predetermined temperature.

Generally, the support assembly 238 has a lower side 226 and an upper side 234. The upper side 234 supports the substrate 240. The lower side 226 has a stem 242 coupled thereto. The stem 242 couples the support assembly 238 to a lift system (not shown) that moves the support assembly 238 between an elevated processing position (as shown) and a lowered position that facilitates substrate transfer to and from the processing chamber 202. The stem 242 additionally provides a conduit for electrical and thermocouple leads between the support assembly 238 and other components of the system 200.

A bellows 246 is coupled between support assembly 238 (or the stem 242) and the bottom 208 of the processing chamber 202. The bellows 246 provides a vacuum seal between the chamber volume 212 and the atmosphere outside the processing chamber 202 while facilitating vertical movement of the support assembly 238.

In operation, gases are excited in the process volume 212 between the support assembly 238 and the distribution plate assembly 218 by use of RF power supplied by a power source 222 to the gas distribution plate assembly 218, which is positioned between the lid assembly 210 and substrate support assembly 238 (or other electrode positioned within or near the lid assembly of the chamber). The support assembly 238 is generally grounded and it supports a circumscribing shadow frame 248. Generally, the shadow frame 248 prevents deposition at the edge of the glass substrate 240 and support assembly 238 so that the substrate does not stick to the support assembly 238. The support assembly 238 has a plurality of holes 228 disposed therethrough that accept a plurality of lift pins 250.

In operation, fluorine species are generated in the remote plasma region of the processing chamber where a gas, for example, a sulfur hexafluoride containing gas is exposed to remote plasma. The remote plasma disassociates the cleaning gas and the disassociated cleaning gas flows into the processing region of the processing chamber. This plasma cleans deposits, such as silicon and carbon from walls and other components located within the chamber.

In one embodiment of the present invention, sulfur hexafluoride may be used in combination with one or more other fluorine containing gases for cleaning deposits from chamber surfaces. The other fluorine containing gases include molecular fluorine, nitrogen trifluoride, hydrogen fluoride, carbon tetrafluoride, perfluoroethane, and others. Sulfur hexafluoride requires more power to dissociate than other fluorine containing gases. Also, sulfur hexafluoride gases must be dissociated to have the ability to clean. The likelihood of dissociation increases with the presence of additional gases. The additional gases that may be added to the system during cleaning include argon, oxygen containing compounds including oxygen and nitrous oxide, or combinations thereof. Testing indicates that nitrous oxide is not as effective as oxygen.

In one of the embodiments of chamber cleaning methods described herein, the cleaning gas may be a halogen-containing gas, such as a fluorine-containing gas. In one embodiment of the present invention, the cleaning gas is NF₃. Other cleaning gases such as: F₂, C₂F₄, SF₆, C₂F₆, CCl₄, and C₂Cl₆ can also be used.

In one embodiment, nitrogen trifluoride (NF₃) may be used as the fluorine containing precursor. Nitrogen trifluoride may be used as a chamber cleaning precursor gas because the mechanical components and other process parameters may be selected to achieve low emission with remote plasma source technology and conventional abatement systems. Molecular fluorine may also be used as a chamber cleaning precursor gas because of the reduced environmental impact and potentially lower operation costs.

In one embodiment of the present invention, the mechanisms for performing plasma cleaning may include remote plasma cleaning, in situ plasma cleaning, and combination thereof. For example, remote plasma cleaning process may include maintaining a plasma in a remote plasma source and providing the plasma to the chamber. For example, an in situ plasma cleaning step may include maintaining a plasma within the chamber through power to the showerhead, substrate support, and/or coils about the chamber. In one embodiment, the controller 190 may schedule plasma cleaning time for each of the processing chambers of system 100 in a sequential fashion in order to avoid any overlapping time periods.

In one embodiment, the controller 190 is configured to monitor the number and duration of each deposition step for each chamber 110, 118, 112, 120 and 114. The controller 190 staggers the plasma cleaning for process chambers 110, 118, 112, 120 and 114, in such a fashion that they are not overlapping in order to provide for a maximum throughput. The controller 190, in communication with a processing substrate system 100, is configured to schedule plasma cleaning for each of the processing chambers 110, 118, 112, 120 and 114 at distinct, non-overlapping time periods to further enhance the overall system throughput.

In one embodiment, the substrate processing system 100 processes twenty or less substrate in one of the substrate processing chambers 110, 118, 112, 120 and 114, before a plasma cleaning is performed. In another embodiment, the substrate processing system 100 processes ten or less substrates in one of the substrate processing chambers 110, 118, 112, 120 and 114, before a plasma cleaning is performed.

In one embodiment, a deposition process in the substrate processing system 100 may be between ten seconds and about six hundred seconds for one of the chambers 110, 118, 112, and 114. In yet another embodiment of the present invention, a deposition process may be between ten seconds and about ninety seconds for one of the substrate processing chambers 110, 118, 112, and 114.

In one embodiment, substrate plasma cleaning times are scheduled alternatively, at distinct, staggered, and non-overlapping time periods in order to obtain an improved chamber processing throughput. Otherwise, when a number of process chambers are finished with plasma cleaning at the same time, the transfer chamber robot would have delays in providing substrates to the process chambers in a time effective manner. Thus, the utilization of the process chambers may be lowered and the throughput of the system may be adversely affected. On the other hand, the invention provides for staggered substrate chamber plasma cleaning times that are scheduled alternatively at distinct, non-overlapping time periods for a cluster tool system with a plurality of substrate processing chambers. In some embodiments, staggering the plasma cleaning allows the transfer chamber to provide substrates to a processing chamber right after the process chamber has been cleaned. In this way, the process chamber is not waiting idle for a substrate to be delivered by the robot and thus, bottlenecks can be avoided.

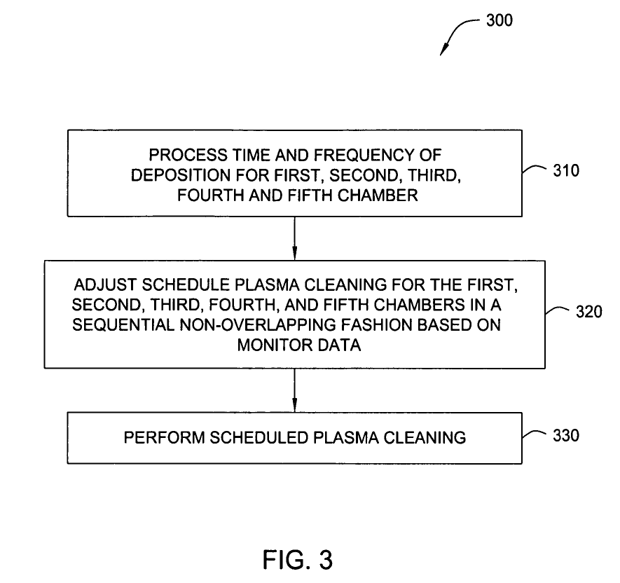

FIG. 3 illustrates operations 300 according to an embodiment of the present invention. The operations 300 may be performed, for example, by the controller 190. The operations may be best understood with simultaneous reference to FIG. 1, which illustrates an exemplary cluster tool system 100.

Since each chamber may be designated to process a different material type with a different processing time, the operations begin, at step 310, by processing time and frequency of deposition for a first, second, third, fourth, and a fifth chamber. The controller may schedule a plasma cleaning for each of five chambers in a sequential non-overlapping fashion. For some embodiments, the controller may store the scheduling in a hardware medium and it may display the scheduling on a computer screen. At this step, the order in which the chambers are scheduled for plasma cleaning depends on the process type and length of the processing time that each chamber is designated to process.

At step 320, the controller 190 examines the processing time and frequency of the chamber process step for each of the processing chambers and may adjust the scheduled plasma cleaning for the chambers in sequential non-overlapping fashion. At step 330, the controller stops the scheduled chamber for plasma cleaning, it may display an alert on the screen (not shown), and automatically after completion of cleaning, it may schedule a processing step for the cleaned chamber to resume substrate processing.

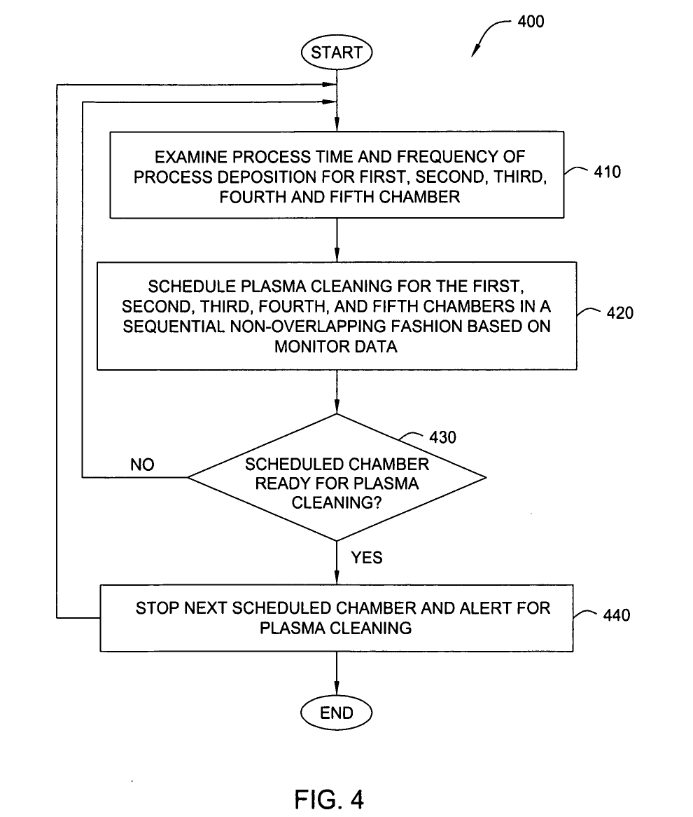

FIG. 4 illustrates operations 400 according to another embodiment of the present invention. The operations 400 may be best understood with simultaneous references to FIGS. 1 and 2, which illustrate, respectively, an exemplary cluster tool system 100 and a schematic cross-sectional view of a processing chamber adapted for remote plasma cleaning. Operations 400 illustrates a method for scheduling plasma cleaning for processing chambers of substrate processing system 100 according to one or more embodiments of the invention. In one embodiment of the present invention, the controller 190 is configured to monitor processing time and frequency of chamber process steps for each of the processing chambers 110, 118, 112, 120 and 114.

The operations begin at step 410, when the controller 190 examines the process time and frequency of chamber process steps for chambers 110, 118, 112, 120 and 114. Each chamber may be designated to process a different material type with a different processing duration.

At step 420, the controller 190 schedules plasma cleaning for each of five chambers 110, 118, 112, 120 and 114 in a sequential non-overlapping fashion. At this step, the order in which the chambers are scheduled for plasma cleaning depends on the process type and length of the processing time that each chamber is designated to process.

In one embodiment, a first CVD chamber and a second CVD chamber of the substrate processing system 100 of the invention maybe designated to process a three-layer deposition process where two thin layers of a first material are used to sandwich a thicker layer of a second material. In general, a thicker film/layer takes a longer time to deposit and therefore, that could affect the frequency of the scheduling. Thus, a chamber that is designated to deposit a thicker material layer may be scheduled for plasma cleaning more frequently than other chambers at step 420.

At step 430, the controller 190 examines the processing time and frequency of the chamber process step for each of the processing chambers 110, 118, 112, 120 and 114 to determine whether one of chambers 110, 118, 112, 120 or 114 is needed to be stopped for plasma cleaning. At step 440, the controller stops the next scheduled chamber and it may automatically start a plasma cleaning process (i.e., remote plasma cleaning process as described above), and then schedule the chamber, after it is cleaned, for a substrate processing step. The process 400 is continually repeated while the system 100 is in operation.

### EXAMPLE

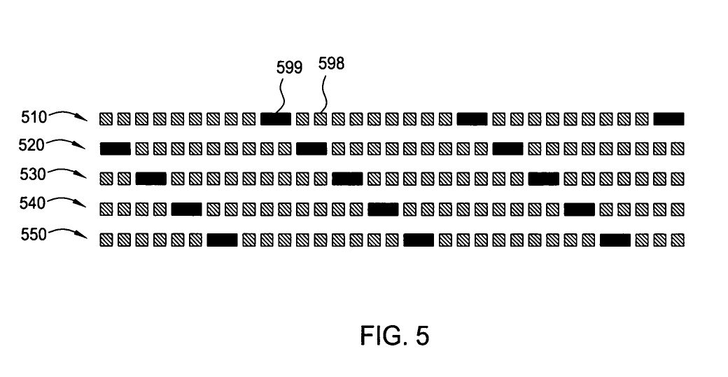

To simulate the invention, a cluster tool system 100, for example an AKT-20K PECVD system, is utilized for substrate processing. For this experiment, substrates are routed through an AKT-20K PECVD system, which includes five process chambers for substrate processing. Substrates are routed from a loadlock to a process chamber, after processing, they are returned back to the loadlock. FIG. 5 depicts a chronological plot of this chamber activity, including chamber plasma cleaning according to one embodiment of the invention. Each row in FIG. 5 corresponds to a chronological chamber activity for a single processing chamber. Rows 510, 520, 530, 540 and 550, each respectively, correspond to a chronological processing chamber activity of a first, second, third, fourth and fifth processing chambers in the system, according to an embodiment of the present invention. As illustrated, plasma cleaning steps are shown by rectangular shaped blocks for each chamber, for example, block 599, and processing steps for each processing chamber are illustrated by square-shaped blocks, for example block 598. As shown, the plasma cleaning for the first, second, third, fourth and fifth chambers occur at distinct, non-overlapping time periods for a maximum throughput. In this embodiment of the invention, the controller schedules plasma cleaning time for each of the processing chambers at distinct, non-overlapping time periods to further enhance the overall system throughput. Utilizing this embodiment of the present invention, in a simulation, the average throughput is calculated to be 66.5 substrates per hour.

While the foregoing is directed to embodiments of the invention, other and further embodiments of the invention may be devised without departing from the basic scope thereof, and the scope thereof is determined by the claims that follow.

1. A method for processing a plurality of substrates in a processing system having four or more process chambers, comprising:
processing each substrate in at least one of the four or more process chambers; and
plasma cleaning each of the four or more process chambers after processing one or more substrates, wherein the four or more process chambers are cleaned at distinct, non-overlapping time periods, selected by a controller to enhance throughput of the substrates through the processing system.

2. The processing method of claim 1, wherein the at least one of the four or more chambers is a chemical vapor deposition chamber.

3. The method of claim 1, wherein the at least one of the four or more process chambers is a plasma enhanced chemical vapor deposition chamber.

4. The processing system of claim 1, wherein the controller is further adapted to generate an alert when each of the four or more process chambers is being scheduled for plasma cleaning.

5. The processing system of claim 1, wherein the controller is adapted to modify a plasma cleaning schedule for one of the four or more process chambers.

6. A method for processing a plurality of substrates in a processing system having five or more process chambers, comprising:
processing twenty or less substrates in each one of the five or more process chambers before plasma cleaning each process chamber;
plasma cleaning the five or more process chambers, wherein each cleaning is performed at a distinct, non-overlapping time period.

7. The method of claim 6, wherein one of the five or more process chambers is a chemical vapor deposition chamber.

8. The method of claim 6, wherein one of the five or more process chamber is a plasma enhanced chemical vapor deposition chamber.

9. The processing method of claim 6, wherein a controller is adapted to generate an alert when a process chamber is being scheduled for cleaning.

10. The processing method of claim 1, wherein the cleaning each of the chambers comprising:
introducing a gas mixture to a remote plasma source;
disassociating a portion of the gas mixture into ions while applying power to the remote plasma source;
transporting the gas mixture into a processing region of the chamber;
cleaning a deposit from within the chamber by reaction with the ions while providing an in situ plasma; and
exhausting a combination of the gas mixture and deposit from the chamber.

11. The method of claim 10, further comprising sending a signal from an end point detector to a controller.

12. The method of claim 10, wherein the in situ plasma is formed by applying RF power.

13. The processing method of claim 6, wherein the cleaning each of the chambers comprising:
introducing a gas mixture to a remote plasma source;
disassociating a portion of the gas mixture while applying power to the remote plasma source;
transporting the gas mixture into a processing region of the chamber;
cleaning a deposit from within the chamber by reaction while providing an in situ plasma; and
exhausting a combination of the gas mixture and deposit from the chamber.

14. The method of claim 13, further comprising sending a signal from an end point detector to a controller.

15. The method of claim 13, wherein the in situ plasma is formed by applying RF power.

16. The method of claim 10, wherein a cleaning gas may be a halogen-containing gas.

17. The method of claim 16, wherein the cleaning gas is a fluorine-containing gas.

18. The method of claim 16, wherein the cleaning gas is at least one of the group consisting of NF₃, F₂, C₂F₄, SF₆, C₂F₆, CCl₄, and C₂Cl₆.

19. The method of claim 6, wherein ten or less substrates are processed in each one of the five or more process chambers before plasma cleaning each process chamber is performed.

20. The method of claim 1, wherein ten or less substrates are processed in each one of the at least one of the four or more process chambers before plasma cleaning each process chamber is performed.
